(19) United States
(12) Patent Application Publication
(10) Pub. No.: US 2012/0192280 A1
(43) Pub. Date: Jul. 26, 2012

(54) APPARATUS FOR ENHANCING WEB APPLICATION SECURITY AND METHOD THEREFOR

(75) Inventors: V.N. Venkatakrishnan, Chicago, IL (US); Prithvi Bisht, Vernon Hills, IL (US); A. Prasad Sistla, Glenview, IL (US)

(73) Assignee: Board of Trustees of the University of Illinois, Chicago, IL (US)

(21) Appl. No.: 13/351,853

(22) Filed: Jan. 17, 2012

Related U.S. Application Data
(60) Provisional application No. 61/434,624, filed on Jan. 20, 2011.

(51) Int. Cl. G06F 21/00

(52) U.S. Cl. 726/25

(57) ABSTRACT

A system that incorporates teachings of the present disclosure may include, for example, constructing a symbolic representation from a portion of a web application that generates a plurality of structured query language (SQL) queries, parsing the symbolic representation into a plurality of trees, and adapting the web application with PREPARE statements according to the plurality of trees. Additional embodiments are disclosed.

### PRIOR APPLICATION

The present application claims the benefit of priority to U.S. Provisional Application No. 61/434,624 filed on Jan. 20, 2011, which is hereby incorporated herein by reference.

### STATEMENT AS TO FEDERALLY SPONSORED RESEARCH

This invention was made with government support under grant or contract no 0845894, 0917229, 0716584, and 09164438 awarded by the National Science Foundation. The government has certain rights in this invention.

### FIELD OF THE DISCLOSURE

The present disclosure relates generally to security techniques, and more specifically to an apparatus for enhancing web application security and method therefor.

### BACKGROUND

In the last decade, the Web has rapidly transitioned to an attractive platform, and web applications have significantly contributed to this growth. Unfortunately, this transition has resulted in serious security problems that target web applications. A recent survey by the security firm Symantec suggests that malicious content is increasingly being delivered by Web based attacks [2], of which SQL injection attacks (SQLIA) have been of widespread prevalence. For instance, the SQLIA based Heartland data breach¹ allegedly resulted in information theft of 130 million credit/debit cards. ¹ http://www.wired.com/threatlevel/2009/08/tjx-hacker-charged-with-heartland

SQL injection attacks are a prime example of malicious input that change the behavior of a program by sly introduction of query structure into the input strings. An application that does not perform input validation (or employs error-prone validation) is vulnerable to SQL injection attacks.

There is an emerging consensus in the software industry that using PREPARE statements to construct SQL queries constitutes a robust defense against SQL injections. PREPARE statements allow a programmer to easily isolate and confine the “data” portions of the SQL query from its “code”, avoiding the need for (error-prone) sanitization of user inputs. In addition, they are efficient because they do not require any runtime tracking, and also provide opportunities for the DBMS server for query optimization [1, 11].

The existing practice to transform an existing application to make use of PREPARE statements requires detailed manual effort, which can be tedious and prohibitively expensive for large applications.

### BRIEF DESCRIPTION OF THE DRAWINGS

FIG. 1 depicts an illustrative embodiment of TAPS: step (1) generates symbolic queries, steps (2-3) separate data reaching the queries, step (4) removes data from symbolic queries, and steps (5-6) generate the transformed program;

FIG. 2 depicts an illustrative embodiment of a labeled derivation tree for symbolic values of q after execution of statement 6;

FIG. 3 depicts an illustrative diagrammatic representation of a machine in the form of a computer system within which a set of instructions, when executed, may cause the machine to perform any one or more of the methodologies disclosed herein;

Table 1 depicts an illustrative embodiment of Effectiveness suite applications, transformed SQL sinks and control flows: TAPS transformed over 93% and 99% of the analyzed control flows for the two largest applications; and

Table 2 depicts an illustrative embodiment of Transformation changed less than 5% lines for large applications.

### DETAILED DESCRIPTION

The present disclosure describes an automated program transformation approach that transforms an existing web application to make use of PREPARE statements. A challenge in doing this transformation is to ensure that the semantics of the transformed program on non-attack inputs is the same as the original program. The present disclosure describes a tool called TAPS (Tool for Automatically Preparing SQL queries). TAPS uses a novel approach to obtain an understanding of the string operations of the program using symbolic evaluation, and effectively rewrites the program with this understanding.

The tool described by the present disclosure has been successfully applied to several real world applications, including one with over 22,000 lines of code. In addition, some of these applications were vulnerable to widely publicized SQL injection attacks present in the CVE database, and the transformation performed by the tool renders them safe by construction. The tool described by the present disclosure can assist developers and system administrators to automatically retrofit their programs with the “textbook defense” for SQL injection.

There has been extensive work on detecting SQL injection vulnerabilities as well as approaches for defending attacks. Due to space limitations, the present disclosure briefly summarizes them here (see [27] for a detailed discussion).

Defenses based on static analysis. There has been extensive research on static analysis to detect whether an application is vulnerable [23, 31, 8, 15, 14, 33, 30, 12]. The most common theme of detection approaches is to reason about sources (user inputs) and their influence on query strings issued at sinks (sensitive operations) or intermediate points (sanitization routines). The embodiments discussed in the present disclosure provides means for fixing such vulnerabilities through PREPARE statements.

Defenses based on dynamic analysis. Dynamic prevention of SQLIA is a fairly well researched area and has a large body of well understood prevention techniques [4, 32, 7, 24, 13, 5, 3, 29, 27, 21, 26, 25, 28, 22, 19]. At a high level, all these techniques track use of untrusted inputs through a reference monitor to prevent exploits. Unlike the above approaches, the high-level goal of TAPS is not to monitor the program—the goal here is to modify the program to eliminate the root causes of vulnerabilities—isolation of program generated queries from user data while avoiding any monitoring costs.

Automated PREPARE statement generation. [6] investigates the problem of automatically converting programs to generate PREPARE statements. This approach assumes that the entire symbolic query string is directly available at the sinks. This assumption does not hold in many typical applications that construct queries dynamically.

We use the following running example: a program that computes a

| SELECT query with a user input $u | |
|---|---|
| 1. | $u = input ( ); |
| 2. | $q1 = “select * from X where uid LIKE ‘%”; |
| 3. | $q2 = f($u); // f - filter function |
| 4. | $q3 = “%’ order by Y”; |
| 5. | $q = $q1.$q2.$q3; |
| 6. | sql.execute ($q); |

The above code applies a (filter) function (f) on the input ($u) and then combines it with constant strings to generate a query.

The running example is vulnerable to SQL injection if input $u can be injected with malicious content and the filter function t fails to eliminate it. For example, the user input ‘OR 1=1—provided as $u in the above example can break out of the expected string literal context and add an additional OR clause to the query. Typically, user inputs such as $u are expected to contribute to queries as literals in the parse structure of any query: more specifically, in one of the two literal data contexts: (a) a string literal context which is enclosed by program supplied string delimiters (single quotes) (b) in a numeric literal context. SQL injection attacks violate this expectation by introducing input strings that do not remain confined to these literal data contexts and directly influence the structure of the generated queries [5, 27].

A PREPARE statement, a facility provided by many database platforms, confines all query arguments to the expected data contexts. These statements allow a programmer to declare (and finalize) the structure of every SQL query in the application. Once issued, the parse structure of the queries is frozen and cannot be altered by malformed inputs. The following is an equivalent PREPARE statement based program for the running example.

| | |
|---|---|
| 1. | $q = “select * from X where uid LIKE ? order by Y”; |
| 2. | $stmt = prepare ($q) .bindParam (0, “s”, “%“.f($u) .%”); |
| 3. | $stmt.execute( ); |

The question mark in the query string $q is a “place-holder” for the query argument % f ($u) %. In the above example, providing the malicious input u=‘ or 1=1—to the prepared query will not result in a successful attack. This is because the actual query is parsed with these placeholders (prepare instruction), and the actual binding to placeholders happens after the query structure is finalized (bindParam instruction). Therefore, the malicious content from $u cannot influence the structure of query. In addition, PREPARE statements also aid in faster query processing and optimization and we refer to [1, 11] for a discussion on this subject.

The Transformation Problem: It is an objective of the present disclosure to replace all queries generated by a web application with equivalent PREPARE statements. A web application can be viewed as a SQL query generator that combines constant strings supplied by the program with computations over user inputs.

Given a large web application, making a change to PREPARE statements is challenging and tedious to achieve through manual transformation. To make the change, a developer must consider each SQL query location (sink) of the program and queries that it may execute. A sink may execute several different queries, each corresponding to the control path taken in the program. Looping behavior may be used to introduce a variety of repeated operations, such as construction of conditional clauses that involve user inputs. Sinks that execute multiple queries need to be transformed such that each control path gets its corresponding PREPARE statement. This requires a developer to consider all control flows together. Also, each such control flow may span multiple procedures and modules and thus requires an analysis spanning several procedures across the source code.

A second issue in making this change is: for each control flow, a developer must extract query arguments from the original program statements. This requires reasoning about the data contexts. In the running example, the query argument % f ($u) % is generated at line 5, and three statements provide its value: f ($u) from line 3, and enclosing character (%) from line 2 and 4, respectively. The above mentioned issues make the problem of isolating user input data from the original program query quite challenging.

We will use the running example from the previous section. This application takes a user input $u and constructs a query in the partial query string variable $q. A partial query string variable is a variable that holds a query fragment consisting of sonic string constants supplied by the program code together with user inputs. Our approach makes the following assumption about partial query strings.

We require the web application to be transformed, to not perform content processing or inspection of partial query string variables.

To guarantee the correctness of our approach, we require this assumption to hold. To explain this assumption for the running example, we require that once the query string $q is formed in line 5 of the application by concatenating filtered user input f ($u) with program generated constant strings in variables $q1 and $q3, it does not undergo deep string processing (i.e., splitting, character level access, etc.,) further en route to the sink. To ensure that this assumption holds, our approach and implementation checks the program code only performs the following operations on partial query string variables: (a) append with other program generated constant strings or program variables (b) perform output operations (such as writing to a log file) that are independent of query construction and (c) equality comparison with string constant null. Checking the above three conditions is sufficient to guarantee that our main assumption holds.

The above conditions are in fact conservative and can be relaxed by the developer, but we believe that the above assumption is not very limiting based on our experimental evaluation of many real world open source applications. In fact, the above assumption has been implicitly held by many prior approaches in SQL injection defense. Defenses such as SQLRand [4]. SQLCheck [27] are indeed applicable on real world programs because this assumption holds for their target applications. We note that all of these approaches change the original program's data values. SQLR and randomizes the program generated keywords, SQLCheck encloses the original program inputs with marker tags. These approaches then require that programs do not manipulate their partial query strings in arbitrary ways. For instance, if a program splits and acts on a partial query string after its SQL keywords have been randomized, it introduces the possibility of losing the effect of randomization. A small minority of query generation statements in sonic programs may not conform to our main criteria; in this case, our tool reports a warning and requires programmer involvement as discussed below.

As mentioned earlier, user inputs are expected to contribute to SQL queries in string and numeric data literal contexts. Our approach aims to isolate these (possibly unsafe) inputs from the query by replacing existing query locations in the source code with PREPARE statements, and replacing the unsafe inputs in them with safe placeholder strings. These placeholders will be bound to the unsafe inputs during program execution (at runtime).

In order to do this, we first observe that the original program's instructions already contain the programmatic logic (in terms of string operations) to build the structure of its SQL queries. This leads to one embodiment behind our approach: if we can precisely identify the program data variable that contributes a specific argument to a query, then replacing this variable with a safe placeholder strings (?) will enable the program to programmatically compute the PREPARE statement at runtime. The above approach will work correctly if our main assumption is satisfied. We indeed can ensure that the resulting string with placeholders at the original SQL sink will have (at runtime) the body of a corresponding PREPARE statement.

The problem therefore reduces to precisely identifying query arguments that are computed through program instructions. In our approach, we solve this problem through symbolic execution [20], a well-known technique in program verification. Intuitively, during any run, the SQL query generated by a program can be represented as a symbolic expression over a set of program inputs (and functions over those inputs) and program-generated string constants. For instance, by symbolically executing our running example program, we obtain the following symbolic query expression:
SELECT . . . WHERE uid LIKE ‘% f($u) %’ ORDER by Y

Notice that the query is expressed completely by constant strings generated by the program, and (functions over) user inputs. (We will define these symbolic expressions formally later.)

Once we obtain the symbolic expression, we analyze its parse structure to identify data arguments for the PREPARE statement. In our running example, the only argument obtained from user input is the string % f ($u) %.

Our final step is to traverse the program backwards to the program statements that generate these arguments, and modify them to generate placeholder (?) instead. Now, we have changed a data variable of a program, such that the program can compute the body of the PREPARE statement at runtime.

In our running example, after replacing contributions of program statements that generated the query data argument % f ($u) % with a placeholder (?), $q at line 5 contains the following PREPARE statement body at runtime:
SELECT . . . WHERE uid LIKE? ORDER by Y, %$q2%

The corresponding query argument is the value %$q2%. Note that the query argument includes contributions from program constants (such as %) as well as user input (through $q2).

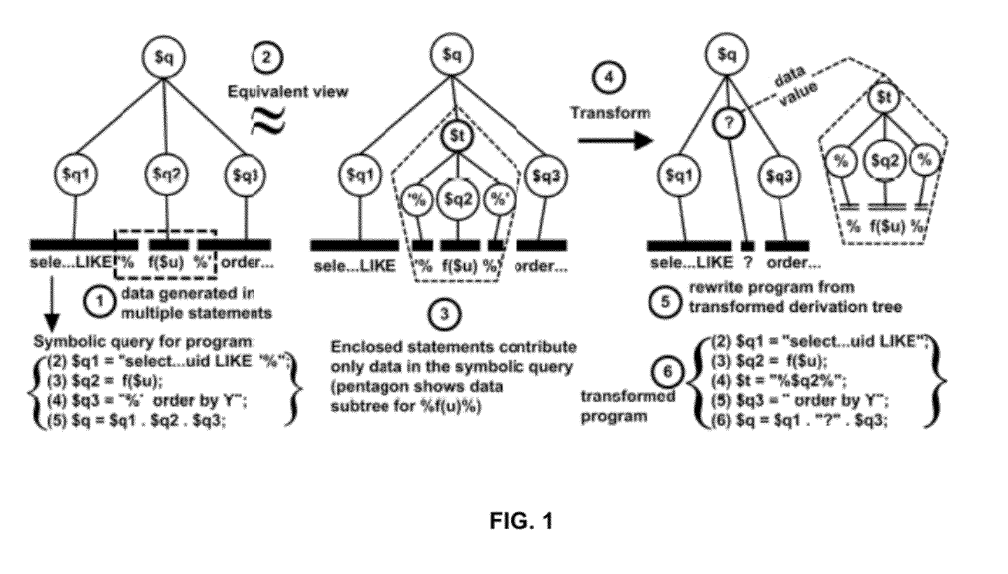

Approach overview. FIG. 1 gives an overview of our approach for the running example. For each path in the web application that leads to a query, we generate a derivation tree that represents the structure of the symbolic expression for that query. For our example, $q is the variable that holds the query, and step 1 of this figure shows the derivation tree rooted at $q that captures the query structure. The structure of this tree is analyzed to identify the contributions of user inputs and program constants to data arguments of the query, as shown in steps 2 and 3. In particular, we want to identify the subtree of this derivation tree that confines the string and numeric literals, which we call the data subtree. In step 4, we transform this derivation tree to introduce the placeholder value, and isolate the data arguments. This change corresponds to a change in the original program instructions and data values. In the final step 5, the rewritten program is regenerated. The transformed program programmatically computes the body of the PREPARE statement in variable $q and the associated argument in variable $t.

Formal description for straight line programs. We give a more precise description using a simple well defined programming language. We assume that all the variables in the language are string variables. Let ⊚ denote string concatenation operator. The allowed statements in the language are of the following forms: x=f( ), x=y, x=y1·y2 where x is a variable and y is a variable or a constant, y1, y2 are variables or constants with the constraint that at most one of them is a constant, and f(0) is any function including the input function that accepts inputs from the user. Here we describe our approach for straight line programs. Processing of more complex programs that include conditional statements and certain type of simple loops is presented later in this section. The approach for such complex programs uses the procedure for straight line programs as a building block.

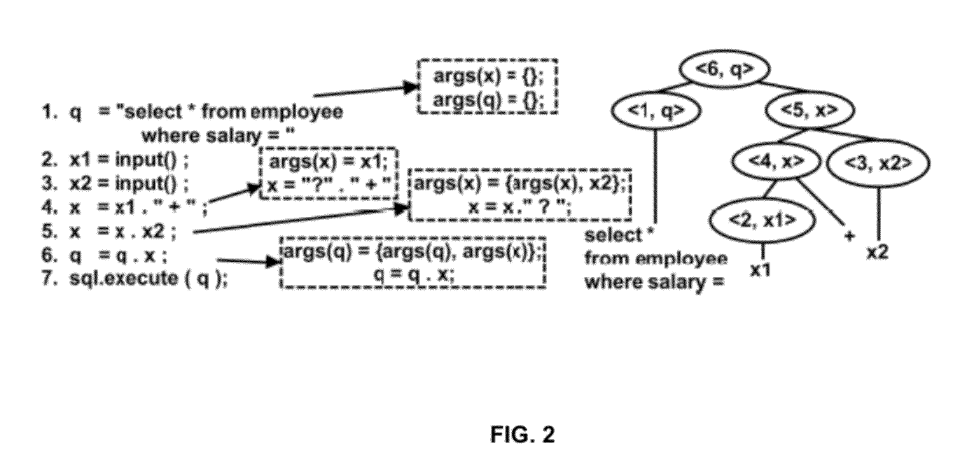

Derivation Trees. Now consider a straight line program P involving the above type of statements. Assume that P has l number of statements. We let Sᵢ denote the i^{th} statement in P. With each i, 1≦i≦l, we define a labeled binary tree Tᵢ as follows. Let x=e be the statement Sᵢ. Intuitively, Tᵢ shows the derivation tree for the symbolic value of x immediately after execution of Sᵢ. The root node r of Tᵢ is labeled with the pair (i, x) and its children are defined as follows. If e is f( ) or c, where c is constant string, then r has a single child that is a leaf node and that is labeled with x or c, respectively. If e is variable y and j is the last statement before i that updates y, then r has a single sub-tree which is a copy of Tⱼ. If e is y·z then r has two sub-trees. If y is a constant then the left sub-tree is a leaf node labeled with the constant, otherwise the left sub-tree is defined as follows. If variable y is updated some time before Sᵢ, and j is the last statement before Sᵢ that updated y, then the left-subtree of r is a copy of tree Tⱼ; otherwise, the left sub-tree is a leaf node labeled with y. The right sub-tree of r is defined similarly using z instead of y. FIG. 2 gives a program and the tree T₆ for this program.

Symbolic strings. For the program P, we construct the trees Tᵢ, for 1≦i≦l. For each tree Tᵢ, we define a symbolic string, called the string generated by Tᵢ, as the string obtained by concatenating the labels of leaves of Tᵢ from left to right. If Sᵢ is of the form x=e, then we define the symbolic value of x after Sᵢ to be the symbolic string generated by Tᵢ. For the program given in FIG. 2, the symbolic value of q after statement 6 is the string select * from employee where salary=x1+x2

Data sub-strings. Assume that the last statement of P is sql.execute(q) and that this is the only sql statement in P. Also assume that statement i is the last statement that updated y. We obtain the symbolic value s of q after statement i from the tree Tᵢ and parse it using the sql parser. If it is not successfully parsed then we reject the program. Otherwise, we do as follows. From the parse tree for s, we identify the sub-strings of s that correspond to data portions. We call these sub-strings as data sub-strings. For each data sub-string u, we identify the smallest sub-tree τᵤ, called data sub-tree, of Tᵢ that generated u. Note that τᵤ is a copy of Tⱼ for sonic j≦i. Clearly, u is a sub-string of the string generated by τᵤ. Now, we consider the case when the following property (*) is satisfied. (If (*) is not satisfied we transform P into an equivalent program P′ that satisfies (*) and we invoke the following procedure on P′; this transformation is described later).

Property (*): For each data sub-string u, u is equal to the string generated by τᵤ.

Program Transformation. We modify the program so that data sub-strings in symbolic strings are replaced by ? and all such data sub-strings are gathered into argument lists. We achieve this as follows. For each relevant variable x, we introduce a new variable args(x) that contains its list of arguments and initialize it to the empty lists in the beginning. Let the root node of sub-tree τᵤ in Tᵢ be rᵤ. We traverse the tree Tᵢ from node rᵤ to its root and let t₁, . . . , tₖ be the nodes on this path in that order. Note that t₁=rᵤ and tₖ is the root of Tᵢ. For each j, 1≦j≦k, let the label of node t be given by <nbr(j), var(j)>. Let j′ be the smallest integer such that 1<j′≦k and t_{j′} has two children. Clearly, the statement S_{nbr(j′)} is of the form var(j′)=y′·z′.

We replace S_{nbr(j′)} by a sequence of two statements, denoted by New(S_{nbr(j′)}), as follows. If t_{j′-1} is a left child of then New(S_{nbr(j′)}) consists of a statement U followed by the statement var(j′)=“?”·z′. The statement U is defined as follows: If z′ is a constant string then U sets args(var(j′)) to be the list consisting of the single variable y′ (note that y′=var(j′−1)); otherwise, U sets args(var(j′)) to be the list obtained by adding y′ to the front of the list args(z′). If t_{j′-1} is a right child of t_{j′} then consists of a statement U followed by the statement var(j′)=y′·“?” where U is as defined previously with the following changes: variable z′ is used in place of y′, args(y′) is used in place of args(z′), and z′ is added at the end of the list args(y′). For each j″, j′<j″≦k, we add an additional statement U immediately before statement Snbr(j″) as follows. If Snbr(j″) is var(j″)=z then U assigns args(z) to args(var(j″)) (note that in this case, z cannot be a constant string). If Snbr(j″) is var(j″)=y′·z′ and both y′, z′ are variables, then U sets args(var(j″)) to be the list obtained by concatenating the lists args(y′) and args(z′) in that order; if Snbr(j″) is of the above form and only one of y′ and z′ is a variable, then U sets args(var(j″)) to be the argument list of that one variable. FIG. 2 shows changes to statement 4, 5 and 6 and initialization of args lists.

Ensuring property (*). Now we consider the case when property (*) is not satisfied. In this case, we transform the program P into another equivalent program for which the property (*) is satisfied. Let Δ be the set of all data sub-strings u of the query string a such that property (*) is violated for them, i.e., u is a strict sub-string of the string generated by τᵤ. Observe that each leaf node of Tᵢ is labeled with a constant string or the name of a variable. For each uεΔ we transform P as follows. Fix any such u. Chose a new variable xᵤ and add a new statement at the beginning of P initializing xᵤ to the empty string. Let v be a leaf node of τᵤ such that the left most element of u falls in the label of v. The label of v can be written as s′*s″ such that s″ is the part that falls in v. Let t₁, . . . , tₖ be the sequence of nodes in τᵤ from the parent of v to rᵤ where rᵤ is the root node of τᵤ. For 1≦j<k, let <nbr(j), var(j)> be the label of node tⱼ. Now change statement S_{nbr(1)} so that the constant used on its right hand side is s′, not s′*s″; this is equivalent to changing the label of v to s′. Add the statement xᵤ=s″*xᵤ immediately before S_{nbr(1)}. For each j, 1<j<k, if tⱼ has two children and tⱼ₋₁ is its left child then do as follows. Assume that S_{nbr(j)} is varⱼ=varⱼ−1·z. Replace S_{nbr(j)} by the following two statements: xᵤ=xᵤ·z, varⱼ=varⱼ₋₁. After this, we identify the leaf node w of τᵤ such that the right most element of falls in the label of w. P is modified in a symmetric fashion updating variable xᵤ.

Now, observe that rᵤ has two children, otherwise τᵤ will not be the smallest sub-tree that generated u. Let the label of rᵤ be <m,y>. Clearly Sₘ is of the form y=z₁·z₂. Replace Sₘ by the following two statements—xᵤ=z₁·xᵤ, y=xᵤ·z₂.

The above transformation is done for each uεΔ. We say that changes corresponding to two different strings in Δ are conflicting if both of them require changes to the same statement of P. Our handling of the cases of conflicting changes is explained in the next section. Here we assume that changes required by different strings in Δ are non-conflicting; Let P′ be the resulting program after changes corresponding to data strings in Δ have been carried out. It can be easily shown that P′ is equivalent to P, i.e., the query string generated in the variable q by P′ is same as the one generated by P. Furthermore, P′ can be shown to satisfy the property (*).

Handling of Conditionals and Procedures. In this section, we discuss our approach and implementation for programs that include branching, functions and loops.

Let us first consider branching statements. For programs that include these constructs, TAPS performs inter-procedural slicing of system dependency graphs (SDGs) [16]. Intuitively, for all queries that a SQL sink may receive, the corresponding SDG captures all program statements that construct these queries (data dependencies) and control flows among these statements. TAPS then computes backward slices for SQL sinks such that each slice represents a unique control path to the sink. Each of these control paths is indeed a straightline program, and is transformed according to our approach described in the previous section. A key issue here is the possibility of conflicts: when path P₁ and P₂ of a program share an instruction (statement) I that contributes to the data argument, then instruction I may not undergo the same transformation along both paths, and TAPS detects such conflicts. Conflict detection and resolution is described in more detail in Section 4.5. Also note that the inter-procedural slicing segregates unique sequences of procedures invoked to construct SQL queries. Such sequences may have multiple intra-procedural flows e.g., conditionals. These SDGs are then split further for each procedure in above construction such that each slice contains a unique control flow within a procedure.

The above discussion captures loop-free programs. Handling loops is challenging as loops in an application can result in an arbitrary number of control paths and therefore we cannot use the above approach of enumerating paths.

Loop Handling. First of all, let us consider programs that construct an entire query inside a single iteration of the loop. Let us call the query so constructed loop independent query. In this case, the body of the loop is a loop-free program that can be handled according to the techniques described earlier. To ensure whether a query location is loop independent, our approach checks for the following sufficient conditions (1) the query location is in the loop body and (2) every variable used in the loop whose value flows into the query location does not depend on any other variable from a previous iteration. Once these conditions are satisfied, our approach handles loop independent queries as described in the earlier section.

However, there may be other instances where loop bodies do not generate entire queries. The most common example are query clauses that are generated by loop iterations. Consider the following example:

1. $u1 = input( ); $u2 = input( );
2. $q1 = “select * from X where Y =”.$u1
3. while ( --$u2 > 0){
4. $u1 = input( );
5. $q2 = $q2.“ OR Y=”.$u1
6. }
7. $q = $q1.$q2
8. sql.execute($q);

In this case, our approach aims to summarize the contributions of the loop using the symbolic regular expressions. In the above case, at the end of the loop, our objective is to summarize the contribution of $q2 as (OR Y=$u1)*, so that the symbolic query expression can now be expressed as

select*from X where Y=$u1(OR Y=$u1)*.

The goal of summarization is essentially to check whether we can introduce place-holders in loop bodies. Once we obtain a summary of the loop, if it is indeed the case that the loop contribution is present in a “repeatable” clause in the SQL grammar, we can introduce placeholders inside the loop. In the above example, since each iteration of the loop produces an OR clause in SQL, we could introduce the placeholder in statement 6, and generate the corresponding PREPARE statement at runtime.

Previous work [33] has shown that the body of a loop can be viewed as a grammar that represents a language contributing to certain parts of the SQL query, and a grammar can be automatically extracted from the loop body as explained there. We will need to check whether the language generated by this grammar is contained in the language spawned by the repeatable (pumped) strings generated by the SQL grammar. Note that this containment problem is not the same as the undeciable general language containment problem for CFGs, as the SQL grammar is a fixed grammar. However, a decision procedure specific to the SQL grammar needs to be built.

We instead take an alternative approach for this problem by ensuring that the loop operations produce regular structures. To infer this we check whether each statement in the body of the loop conforms to the following conditions: (1) the statement is of the form q→x where x is a constant or an input OR (2) it is left recursive of the form q→qx where x itself is not recursive, i.e., resolves to a variable or a constant in each loop iteration. It can be shown that satisfaction of these conditions yields a regular language. The symbolic parser is now augmented to see if the regular structure only generates repeatable strings in the SQL language. If this condition holds, we introduce placeholders as described earlier. We find our strategy for loops quite acceptable in practice, as shown in the next section.

Implementation. We implemented TAPS to assess our approach on PHP applications by leveraging earlier work Pixy [9, 18] and extending it with algorithms to convert programs to Static Single Assignment (SSA) format [10], and then implementation of the transformation described earlier. We briefly discuss some key points below.

We used an off-the-shelf SQL parser and augmented it to recognize symbolic expressions in query strings. The only minor change we had to make was to recognize query strings with associative array references. An associate array access such as $x[‘member’] contains single quotes and may conflict with parsing of string contexts. To avoid premature termination of the data parsing context, TAPS ensures that unescaped string delimiters do not appear in any symbolic expression.

Limitations and Developer Intervention. TAPS requires developer intervention if either one of the following conditions hold (i) the main assumption is violated (Section 4) or (ii) a well-formed SQL query cannot be constructed statically (e.g., use of reflection, library callbacks) (iii) the SQL query is malformed because of infeasible paths that cannot be determined statically (iv) conflicts are detected along various paths (v) query is constructed in a loop that cannot be summarized.

TAPS implements static checks for all of the above and generates reports for all untransformed control flows along with program statements that caused the failure. A developer needs to qualify a failure as (a) generated by an infeasible path and ignore or (b) re-write of violating statements possible. The number of instances of type (a) can be reduced by more sophisticated automated analysis using decision procedures. In case of (b), TAPS can be used after making appropriate changes to the program. In certain cases, the violating statements can be re-written to assist TAPS e.g., a violating loop can be re-written to adhere to a regular structure as described earlier. The remaining cases can either be addressed manually or be selectively handled through other means e.g., dynamic prevention techniques.

In case of failures, TAPS can also be deployed to selectively transform the program such that control paths that are transformed will generate prepared queries, and those untransformed paths will continue to generate the original program's (unsafe) SQL queries. The sufficient condition to do this in a sound manner is that the variables in untransformed part be not dependent (either directly or transitively) on the variables of the transformed paths. In this case, the transformation can be done selectively on sonic paths. All sinks will be transformed to PREPARE statements, and any untransformed paths will make use of the PREPARE statements (albeit with unsafe strings) to issue SQL queries with an empty argument list.

Evaluation. Our evaluation aimed to assess TAPS on two dimensions (a) effectiveness of the approach in transforming real world applications, and (b) performance impact of transformation induced changes.

Effectiveness. Test suite: Table 1 column 1 lists SQLIA vulnerable applications from another research project on static analysis [30] and applications with known SQLIA exploits from Common Vulnerabilities and Exposures (CVE 2009). This table lists their codebase sizes in lines of code and any known CVE vulnerability identifiers (column 2 and 3), number of analyzed SQL sinks and control flows that execute queries at SQL sinks (column 4 and 5), transformed SQL sinks and control flows (column 6 and 7) and number of control flows that required developer intervention (column 8). In this test suite, the larger applications invoked a small number of functions to execute SQL queries. This caused the number of analyzed sinks and control flows to vary across applications.

Transformed control flows. For the three largest applications, TAPS transformed 93%, 99% and 81% of the analyzed control flows. Although smaller in LOC size, the Utopia news pro application had a greater fraction of code involving complex database operations and required analyzing more control flows than any other application. For the remaining applications, TAPS achieved a transformation rate of 100%. This table suggests that TAPS was effective in handling the many diverse ways that were employed by these applications to construct queries.

TAPS did not find any partial query string variables used in operations other than append, null checks and output generation I logging (supports main assumption from Section 4). Further, TAPS did not encounter conflicts while combining changes to program statements required for transformed control flows.

Untransformed control flows The last column of the Table 1 indicates that TAPS requires human intervention to transform some control flows.

As TAPS depends on symbolic evaluation, it did not transform flows that obtained queries at run time e.g., the Warp CMS application used SQL queries from a file to restore the application's database. In two other instances, it executed query specified in a user interface. In both these cases, no meaningful PREPARE statement is possible as external input contributes to the query command. If the source that supplies the query is trusted, then these flows can be allowed by the developer. The limitations of the SQL parser implementation were responsible for two of the three failures in the Utopia news pro application, and the rest are discussed below.

Queries computed in loops A total of 18 control flows used loops that violated restrictions imposed by TAPS and were not transformed (II—Warp CMS, I—Utopia news pro, 6—AlmondSoft). These control flows generated queries in loop bodies that used conditional statements or nested loops. We also found 23 instances of queries computed in loops, including a summarization of implode function, that were successfully transformed. In all such cases queries were either completely constructed and executed in each iteration of the loop or loop contributed a repeatable partial query.

For untransformed flows TAPS precisely identified statements to be analyzed e.g., the Warp CMS application required 195 LOC to be manually analyzed instead of complete codebase of 22K LOC. This is approximately two orders of magnitude reduction in LOC to be analyzed.

Changes to applications As shown in the second column of Table 2 a small fraction of original LOC was modified during transformation. The columns 3 and 4 of this table show average (maximum) number of data arguments extracted from symbolic queries and functions traversed to compute them, respectively, 2% of changes in LOC were recorded for Warp CMS—the largest application, whereas approximately 5% of lines changed for database intensive Utopia new pro application. We noticed that a significant portion of code changes only managed propagation of the data arguments to PREPARE statement. Some of these changes can be eliminated by statically optimizing propagation of arguments list e.g., for all straight line flows that construct a single query, PREPARE statement can be directly assigned the argument list instead of propagating it through the partial queries. Overall, this small percentage of changes points to TAPS's effectiveness in locating and extracting data from partial queries.

Further, as columns 3 and 4 suggest, TAPS extracted a large number of data arguments from symbolic queries constructed in several non-trivial inter-procedural flows. For a manual transformation both of these vectors may lead to increased effort and human mistakes and may require substantial application domain expertise. For successfully transformed symbolic queries the deepest construction spanned 6 functions in the Utopia news pro application and a maximum of 27 arguments (in a single query) were extracted for the Warp CMS application, demonstrating robust identification of arguments.

Performance of transformed applications. TAPS was assessed for performance overhead on a microbench that consisted of an application to issue an insert query. This application did not contain tasks that typically interleave query executions e.g., HTML generation, formatting. Further, the test setup was over a LAN and lacked typical Internet latencies. Overall, the microbench provided a worst case scenario for performance measurement.

We measured end-to-end response times for 10 iterations each with TAPS transformed and original application and varied sizes of data arguments to insert queries from 256B to 2 KB. In sonic instances TAPS transformed application outperformed the original application. However, we did not find any noteworthy trend in such differences and both applications showed same response times in most cases. It is important to note here that dynamic approaches typically increase this overhead by 10-40%. Whereas, TAPS transformed application's performance did not show any differences in response times. Overall, this experiment suggested that TAPS transformed applications do not have any overheads.

Performance of the tool. We profiled TAPS to measure the time spent in the following phases of transformation: conversion of program to SSA format, enumeration of control flows, static checks for violations described earlier, execution tree generation and changing the program. The time taken by each phase is summarized in the last four columns of Table 2. The largest application took around 2 hours to transform whereas the rest took less than an hour. The smallest three applications were transformed in less than 5 seconds. For large applications TAPS spent a majority of time in the SSA conversion. The only exception to this case occurred for AlmondSoft application which had smaller functions in comparison to other applications and hence SSA conversion took lesser time. We wish to note here that TAPS is currently not optimized. A faster SSA conversion implementation may improve performance of the tool and by summarizing basic blocks some redundant computations can be removed. For a static transformation these numbers are acceptable.

Upon reviewing the aforementioned embodiments, it would be evident to an artisan with ordinary skill in the art that said embodiments can be modified, reduced, or enhanced without departing from the scope and spirit of the claims described below. Accordingly, the reader is directed to the claims section for a fuller understanding of the breadth and scope of the present disclosure.

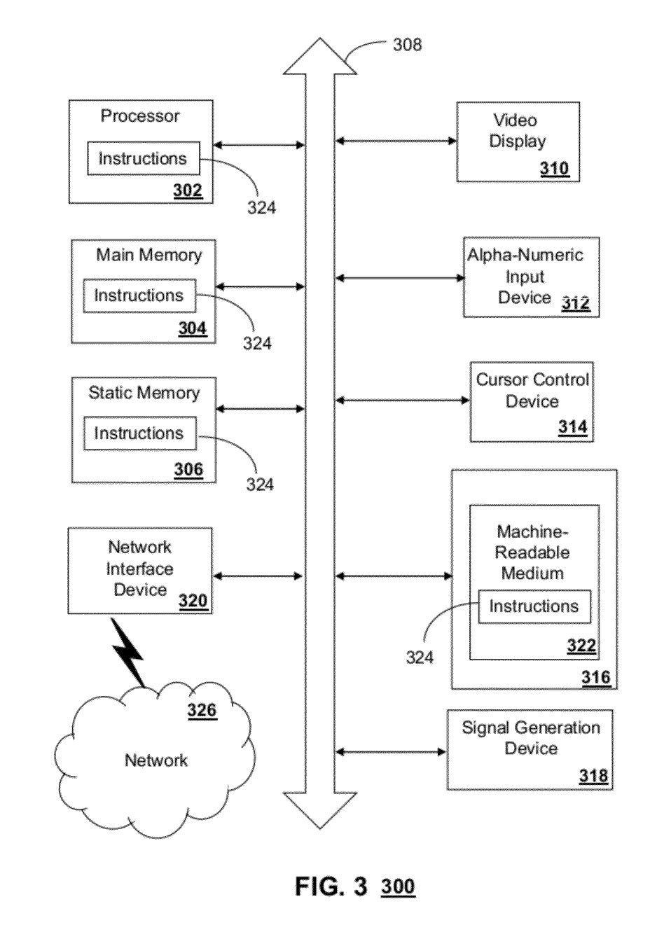

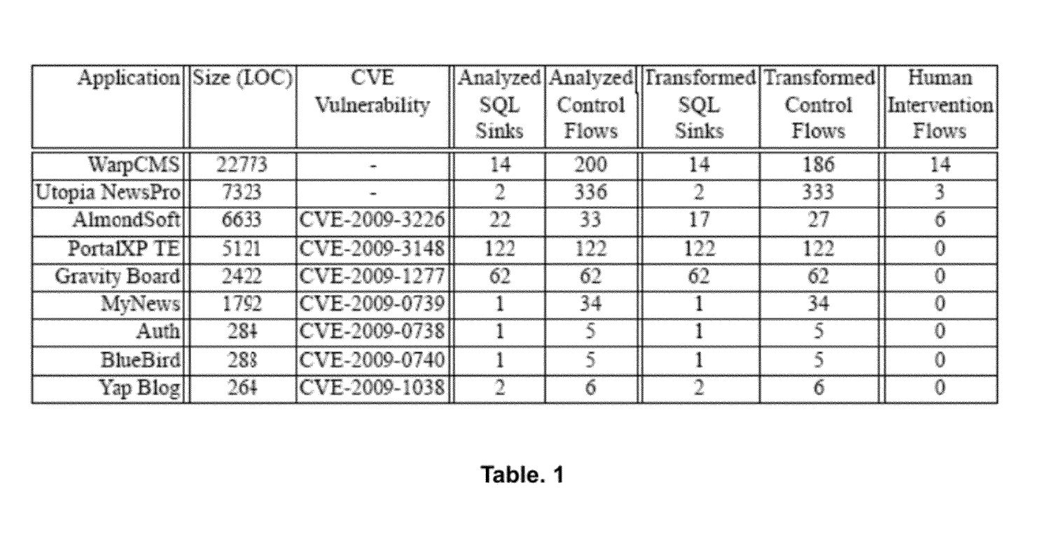

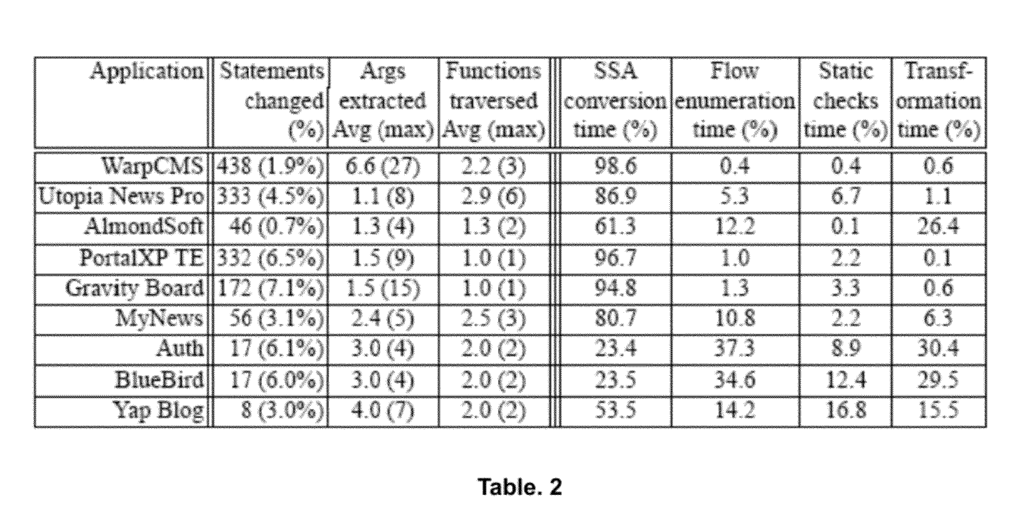

FIG. 3 depicts an exemplary diagrammatic representation of a machine in the form of a computer system 300 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 300 may include a processor 302 (e.g., a central processing unit (CPU), a graphics processing unit (GPU, or both), a main memory 304 and a static memory 306, which communicate with each other via a bus 308. The computer system 300 may further include a video display unit 310 (e.g., a liquid crystal display (LCD), a flat panel, a solid state display, or a cathode ray tube (CRT)). The computer system 300 may include an input device 312 (e.g., a keyboard), a cursor control device 314 (e.g., a mouse), a disk drive unit 316, a signal generation device 318 (e.g., a speaker or remote control) and a network interface device 320.

The disk drive unit 316 may include a machine-readable medium 322 on which is stored one or more sets of instructions (e.g., software 324) embodying any one or more of the methodologies or functions described herein, including those methods illustrated above. The instructions 324 may also reside, completely or at least partially, within the main memory 304, the static memory 306, and/or within the processor 302 during execution thereof by the computer system 300. The main memory 304 and the processor 302 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 324, or that which receives and executes instructions 324 from a propagated signal so that a device connected to a network environment 326 can send or receive voice, video or data, and to communicate over the network 326 using the instructions 324. The instructions 324 may further be transmitted or received over a network 326 via the network interface device 320.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

### REFERENCES

1. Jdbc: Using prepared statements. http://java.sun.com/docs/books/tutorial/jdbc/basics/prepared.html.
2. Symantec Internet Security Threat Report. Technical report, March 2007.
3. Sruthi Bandhakavi, Prithvi Bisht, P. Madhusudan, and V. N. Venkatakrishnan. CANDID: Preventing SQL Injection Attacks using Dynamic Candidate Evaluations. In CCS, 2007.
4. Stephen W Boyd and Angelos D. Keromytis. SQLrand: Preventing SQL Injection Attacks. In ACNS, 2004.
5. Gregory Buehrer, Bruce W. Weide, and Paolo A. G. Sivilotti. Using Parse Tree Validation to Prevent SQL Injection Attacks. In SEM '05, 2005.
6. Fred Dysart and Mark Sherriff. Automated fix generator for sql injection attacks. ISSRE, 2008.
7. A. Tuong et al. Automatically Hardening Web Applications using Precise Tainting, ISC '05.
8. Davide Balzarotti et al. Saner: Composing Static and Dynamic Analysis to Validate Sanitization in Web Applications. In IEEE Security and Privacy, 2008.
9. N. Jevanovic et al. Pixy: a static analysis tool for detecting web app vulnerabilities, SP '06.
10. K. Cytron et al. Efficiently computing static single assignment form and the control dependence graph. PLAS. 1991.
11. H. Flak MYSQL prepared statements.
12. Xiang Fu, Xin Lu, Boris Peltsverger, Shijun Chen, Kai Qian, and Lixin Tao. A static analysis framework for detecting sql injection vulnerabilities. In COMPSAC '07, 2007.
13. William G. J. Halfond, Alessandro Orso, and Panagiotis Manolios. Using Positive Tainting and Syntax-aware Evaluation to Counter SQL Injection Attacks. In FSE, 2000.
14. William G. J. Halfond. Alessandro Orso, and Alessandro Orso. AMNESIA Analysis and Monitoring for NEutralizing SQL-Injection Attacks. In ASE, 2005.
15. William G. J. Halfond, Jeremy Viegas, and Alessandro Orso. A Classification of SQL-Injection Attacks and Countermeasures. In ISSE, 2006.
16. S. Horwitz, T. Reps, and D. Binkley. Interprocedural slicing using dependence graphs. In PLDI, 1988.
17. CVE-2006-2042: Adobe DreamWeaver SQLIA Vulnerability, July 2006.
18. Nenad Jovanovic, Christopher Kruegel, and Engin Kirda. Precise alias analysis for static detection of web application vulnerabilities. In PLAS, 2006.
19. Adam Kiezun, Philip J. Guo, Karthick Jayamman, and Michael D. Ernst. Automatic creation of SQL injection and cross-sire scripting attacks. In ICSE, 2009.
20. James C. King Symbolic execution and program testing. Commun. ACM. 19(7). 1976.
21. Yuji Kosuga, Kenji Kono, Miyuki. Hanaoka, Mho Hishiyama, and Yu Takahama. Sania: Syntactic and semantic analysis for automated testing against sql injection. In ACSAC, 2007.
22. Anyi Liu, Yi Yuan, Duminda Wijesekera, and Angelos Stavrou. Sqlprob: a proxy-based architecture towards preventing sql injection attacks. In SAC, 2009.
23. V. Benjamin Livshits and Monica S. Lam. Finding Security Vulnerabilities in Java Applications with Static Analysis. In USENIX Security Symposium, 2005.
24. Tadeusz Pietraszek and Chris Vanden Berghe. Defending Against Injection Attacks through Context-Sensitive Sting Evaluation. In RAID, 2006.
25. Frank S. Rietta. Application layer intrusion detection for sql injection. In ACM-SE 44, 2006.
26. R. Sekar. An efficient black box technique for defeating web application attacks, ndss '09.
27. Zhendong Su and Gary Wassermann. The Essence of Command Injection Attacks in Web Applications. In ACM Symposium on Principles of Programming Languages (POPL), 2006.
23. Stephen Thomas, Laurie Williams, and Tao Xie. On automated prepared statement generation to remove SQL injection vulnerabilities. IST, 2009.
29. Fredrik Valeur, Darren Mutz, and Giovanni Vigna. A Learning-Based Approach to the Detection of SQL Attacks. In DIMVA, 2005.
30. Gary Wassermann and Zhendong Su. Sound and Precise. Analysis of Web Applications for Injection Vulnerabilities. In PLDI, 2007.
31. Yichen Xie and Alex Aiken. Static Detection of Security Vulnerabilities in Scripting Languages. In USENIX SS, 2006.
32. Wei Xu, Sandeep Bhatkar, and R. Sekar. Taint-Enhanced Policy Enforcement: A Practical Approach to Defeat a Wide Range of Attacks. In USENIX-SS, 2006.
33. Y. Minamide Static approximation of dynamically generated Web pages. In WWW '05.

What is claimed is:

1. A method, comprising:
identifying a procedure used by a web application code to generate a plurality of structured query language (SQL) queries;
identifying from the procedure a portion of the plurality SQL queries subject to SQL injection vulnerability;
generating according to the determined procedure secure interfaces for the portion of the plurality of SQL queries to eliminate SQL injection; and
modifying the web application code according to the generated secure interfaces, while retaining other behaviors in the web application code.

2. The method of claim 1, wherein the secure interfaces comprise PREPARE statements.

3. The method of claim 2, wherein at least a portion of the plurality of SQL queries each comprise a plurality of code steps identified in the procedure, and wherein the method comprises modifying the plurality of code steps to incorporate the generated PREPARE statements in the web application code.

4. The method of claim 1, wherein the other behaviors in the web application code are unrelated to generation of SQL queries.

5. The method of claim 1, comprising determining from the procedure a root cause for SQL injection vulnerability in the portion of the plurality of SQL queries.

6. The method of claim 5, comprising determining the root cause of the SQL injection vulnerability by constructing a symbolic representation from a portion of the web application code that generates the plurality of SQL queries.

7. The method of claim 6, comprising determining the root cause of the SQL injection vulnerability by parsing the symbolic representation into a plurality of trees which represent an algorithm in the web application code.

8. The method of claim 7, wherein the symbolic representation comprises a plurality of structured definitions determined from at least a portion of the plurality of SQL queries generated by the portion of the web application.

9. The method of claim 8, comprising:
parsing the plurality of structured definitions into a plurality of symbolic strings; and
generating the plurality of trees from the plurality of symbolic strings.

10. The method of claim 7, comprising generating a plurality of location tags to identify a relationship between the plurality of SQL queries and the plurality of trees.

11. The method of claim 10, wherein the plurality of location tags are generated during the construction of the symbolic representation.

12. The method of claim 10, comprising:
generating one or more user inputs to invoke one or more corresponding SQL queries from the plurality of SQL queries; and
associating at least one of the plurality of location tags with a corresponding one of the one or more user inputs.

13. The method of claim 10, comprising utilizing the plurality of the location tags during the modifying step to maintain an integrity of an algorithm representative of the web application code.

14. A computer-readable storage medium, comprising computer instructions, which when executed by at least one processor, causes the at least one processor to:
identify a procedure used by a web application code to generate a plurality of structured queries;
identify from the procedure a portion of the plurality structured queries subject to injection vulnerability;
generate according to the determined procedure secure interfaces for the portion of the plurality of structured queries to reduce the injection vulnerability; and
modify the web application code according to the generated secure interfaces.

15. The computer-readable storage medium of claim 14, comprising computer instructions that causes the at least one processor to modify the web application code according to the generated secure interfaces, while retaining other behaviors in the web application code.

16. The computer-readable storage medium of claim 14, wherein the plurality of structured queries comprise at least in part a plurality of structured query language (SQL) queries.

17. A method, comprising:
identifying a procedure used by a web application code;
identifying from the procedure a plurality structured queries subject to injection vulnerability; and
modifying the web application code with secure interfaces to reduce the injection vulnerability.

18. The method of claim 17, modifying the web application code by applying the secure interfaces to at least a portion of the plurality structured queries.

19. The method of claim 17, wherein plurality of structured queries comprise at least in part a plurality of structured query language (SQL) queries.

20. The method of claim 17, comprising modifying the web application code, while retaining other behaviors in the web application code.
